(19) United States
(12) Patent Application Publication
(10) Pub. No.: US 2026/0247218 A1
(43) Pub. Date: Aug. 20, 2026

(54) SYSTEM AND METHOD FOR NETWORK SLICE ADMISSION CONTROL

(71) Applicant: JIO PLATFORMS LIMITED, Ahmedabad, Gujarat (IN)

(72) Inventors: Aayush BHATNAGAR, Navi Mumbai, Maharashtra (IN); Chirag PANT, Lucknow, Uttar Pradesh (IN); Adityakar JHA, Gurgaon, Haryana (IN); Om Prakesh PANDEY, Dwarka, New Delhi (IN); Jatin BANSAL, Barnala, Punjab (IN); Sumedha SATIJA, Panchkula, Haryana (IN); Ankur VERMA, Ghazipur, Uttar Pradesh (IN)

(73) Assignee: JIO PLATFORMS LIMITED, Ahmedabad, Gujarat (IN)

(21) Appl. No.: 18/992,631

(22) PCT Filed: May 6, 2024
(86) PCT No.: PCT/IN2024/050489

§ 371 Date: Jan. 9, 2025

(30) Foreign Application Priority Data
May 30, 2023 (IN) 202321037310

(51) Int. Cl. H04W 28/084; H04W 60/00; H04W 84/04

(52) U.S. Cl. CPC H04W 28/084; H04W 60/002; H04W 84/042

(57) ABSTRACT

The present disclosure provides a system and method for network slice admission control (NSAC). The system includes an NSAC controller comprising an in-instance cache to count the number of user equipment (UE)/packet data unit (PDU) session when numerous UE/PDU sessions are associated with the same network slice. The data from the in-instance cache are synced periodically to a database to ensure consistency between the cached data and the database. The NSAC controller may include a standby instance of NSACF, ensuring high availability (HA) to serve UE/PDU requests with its own in-instance cache during a switch-over.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF DISCLOSURE

The embodiments of the present disclosure generally relate to fifth generation (5G) networks. In particular, the present disclosure relates to maintaining data related to network slice admission control function (NSACF) in 5G networks.

### BACKGROUND OF DISCLOSURE

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In a 5G network, network slices are subject to network slice admission control (NSAC). A network slice admission control function (NSACF) of NSAC keeps track of a number of user equipment (UEs) registered per network slice and/or a number of packet data unit (PDU) sessions per network slice. Further, the NSACF is also configured with a maximum number of UEs and/or PDU sessions that can be associated with a particular single network slice selection assistance information (S-NSSAI). Further, the NSACF includes an access type associated with the S-NSSAI, for example, third generation partnership project (3GPP) Access Type, Non-3GPP Access Type or both.

The NSACF maintains count for UE registration and PDU sessions in a database. For example, when a UE registers or deregisters, the count is incremented or decremented, respectively. The UE/PDU sessions increment/decrement the same database (DB) record, resulting in a DB lock for concurrency control.

There is, therefore, a need in the art to provide a method and a system that can overcome the shortcomings of the existing prior arts.

### SUMMARY

In an exemplary embodiment, a network slice admission control function (NSACF) is described. The NSACF is configured to maintain data in a database. The data comprises number of user equipment (UE) registration per slice per public land mobile network (PLMN), number of packet data unit (PDU) sessions per slice per PLMN, maximum number of UEs and PDU sessions supported per a single—network slice selection assistance information (S-NSSAI), an access management function (AMF) UE context, a session management function (SMF) UE context. The NSACF is further configured to maintain frequently accessed or modified data from the database in a cache. The cache is in sync with the database. The NSACF is configured to be deployed as a first entity and a second entity. The first entity is an active entity, and the second entity is a standby entity. The standby entity is configured to remain up and fetch cache served by the active entity. If the first entity goes down, the NSACF is configured to cause the second entity to function as the active entity and the first entity to function as the standby entity.

In some embodiments, the NSACF is configured to provide slice statistics per access type to indicate percentage of plurality of registered UEs and plurality of PDUs. The access type includes a third-generation partnership project (3GPP) access, non-3GPP access or both.

In some embodiments, the NSACF is configured to provide load distribution percentage of each slice of a plurality of slices based on the AMF. All the AMF/SMF served by each slice is identified based on load distribution percentage of each slice of the plurality of slices. The NSACF is configured to determine UE/PDU load distribution percentage of the plurality of slices served by the AMF/SMF by tracking count of the UEs and the PDUs for all slices with respective PLMNs served by the AMF or the SMF.

In some embodiments, the NSACF is configured to handle traffic from a plurality of network functions (NFs) based on number of UE registration and number of PDU sessions. A NSACF function element (FE) is configured to provide an early admission control (EAC).

In some embodiments, the NSACF is configured to set an EAC flag for the S-NSSAI to be active on determining that the number of UEs registered to the S-NSSAI is above a desired threshold and to set the EAC flag for the S-NSSAI to be inactive on determining that the number of UEs registered to the S-NSSAI is below the desired threshold. In some embodiments, the NSACF is configured to increment/decrement a counter in the cache based on the number of UEs initiated or leaving the session.

In some embodiments, on determining that the UE registers or deregisters, the NSACF is configured to increment or decrement the number of UE registration, respectively.

In another exemplary embodiment, a method for performing network slice admission control by a network slice admission control function (NSACF) is described. The method comprises maintaining data in a database. The data comprises number of user equipment (UE) registration per slice per public land mobile network (PLMN), number of packet data unit (PDU) session per slice per PLMN, maximum number of UEs and PDU sessions supported per a single network slice selection assistance information (S-NSSAI), an access management function (AMF) UE context, a session management function (SMF) UE context. The method further comprises maintaining frequently accessed or modified data from the database in a cache, wherein the cache is in sync with the database. The method further comprises deploying a first entity and a second entity. The first entity is an active entity, and the second entity is a standby entity. The standby entity is configured to remain in standby mode, which is staying up and fetch cache served by the active entity. The method further comprises causing the second entity to function as the active entity and the first entity to function as the standby entity if the first entity goes down.

In some embodiments, the method comprises providing slice statistics per access type to indicate percentage of plurality of registered UEs and plurality of PDUs. The access type includes 3GPP access, non- 3GPP access or both.

In some embodiments, the method comprises providing load distribution percentage of each slice of a plurality of slices based on the AMF. All the AMF/SMF served by each slice is identified based on load distribution percentage of each slice of the plurality of slices. The method further comprises determining UE/PDU load distribution percentage of the plurality of slices served by the AMF/SMF by tracking count of the UEs and the PDUs for all slices with respective PLMNs served by the AMF or the SMF.

In some embodiments, the method comprises handling traffic from a plurality of network functions (NFs) based on number of UE registration and number of PDU sessions. A NSACF function element (FE) is configured to provide an early admission control (EAC) support.

In some embodiments, the method comprises setting an EAC flag for the S-NSSAI to be active on determining that the number of UEs registered to the S-NSSAI is above a desired threshold and setting the EAC flag for the S-NSSAI to be inactive on determining that the number of UEs registered to the S-NSSAI is below the desired threshold.

In some embodiments, the method comprises incrementing/decrementing a counter in the cache based on the number of UEs initiated or leaving the session.

In some embodiments, on determining that the UE registers or deregisters, the method comprises incrementing or decrementing the number of UE registration, respectively.

In yet another exemplary embodiment, a system for performing network slice admission control is described. The system comprises a network slice admission control function (NSACF). The NSACF is configured to maintain data in a database. The data comprises a number of user equipment (UE) registration per slice per public land mobile network (PLMN), a number of packet data unit (PDU) session per slice per PLMN, maximum number of UEs and PDU sessions supported per a single—network slice selection assistance information (S-NSSAI), an access management function (AMF) UE context, and a session management function (SMF) UE context. The NSACF is further configured to maintain frequently accessed or modified data from the database in a cache. The cache is in sync with the database. The NSACF is configured to be deployed as a first entity and a second entity. The first entity is an active entity, and the second entity is a standby entity. The standby entity is configured to remain up and fetch the cache served by the active entity. If the first entity goes down, the NSACF is configured to cause the second entity to function as the active entity and the first entity to function as the standby entity.

In some embodiments, the NSACF is configured to provide slice statistics per access type to indicate percentage of plurality of registered UEs and plurality of PDUs, wherein the access type includes 3GPP access, non- 3GPP access or both.

In some embodiments, the NSACF is configured to provide load distribution percentage of each slice of a plurality of slices based on the AMF. All the AMF/SMF served by each slice is identified based on load distribution percentage of each slice of the plurality of slices. The NSACF is configured to determine UE/PDU load distribution percentage of the plurality of slices served by the AMF/SMF by tracking count of the UEs and the PDUs for all slices with respective PLMNs served by the AMF or the SMF.

In some embodiments, the NSACF is configured to handle traffic from a plurality of network functions (NFs) based on number of UE registration and number of PDU Sessions. A NSACF function element (FE) is configured to provide an early admission control (EAC).

In some embodiments, the NSACF is configured to set an EAC flag for the S-NSSAI to be active on determining that the number of UEs registered to the S-NSSAI is above a desired threshold and to set the EAC flag for the S-NSSAI to be inactive on determining that the number of UEs registered to the S-NSSAI is below the desired threshold.

In some embodiments, the NSACF is configured to increment/decrement a counter in the cache based on the number of UEs initiated or leaving the session.

In some embodiments, on determining that the UE registers or deregisters, the NSACF is configured to increment or decrement the number of UE registration, respectively.

In yet another exemplary embodiment, a user equipment (UE) attached to a network is configured to register with one of a plurality of slices associated with an access management function (AMF). Number of user equipment (UE) registration per slice per public land mobile network (PLMN) is maintained in a database by a network slice admission control function (NSACF). In response to registration with the slice associated with the AMF, the UE is configured to perform a plurality of operations. In response to completion of operation, the UE is configured to deregister with the slice associated with the AMF. On determining that the UE registers or deregisters, the NSACF is configured to increment or decrement the number of UE registration in the database, respectively.

In some embodiments, frequently accessed or modified data from the database is maintained in a cache, wherein the cache is in sync with the database.

In some embodiments, the data comprises number of user equipment (UE) registration per slice per public land mobile network (PLMN), number of packet data unit (PDU) session per slice per PLMN, maximum number of UEs and PDU sessions supported per a single-network slice selection assistance information (S-NSSAI), an access management function (AMF) UE context, and a session management function (SMF) UE context.

In some embodiments, the plurality of operations comprises accessing of data service, voice service or both.

The foregoing general description of the illustrative embodiments and the following detailed description thereof are merely exemplary aspects of the teachings of this disclosure, and are not restrictive.

### Objects of the Present Disclosure

Some of the objects of the present disclosure, which at least one embodiment herein satisfies are as listed herein below.

It is an object of the present disclosure to provide a containerized, high available node, for restricting the number of UE and PDN sessions per slice.

It is another object of the present disclosure is to maintain significant data in in-instance cache.

It is yet another object of the present disclosure is to deploy the NSACF in a pair, with a first peer actively serving requests and a second peer on standby.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components or circuitry commonly used to implement such components.

FIG. 1 illustrates an exemplary network architecture in which or with which a proposed system may be implemented, in accordance with embodiments of the present disclosure.

FIG. 2A illustrates an exemplary block diagram of a network slice admission control (NSAC) architecture, in accordance with embodiments of the present disclosure.

FIG. 2B illustrates an exemplary flow diagram for network slice admission control performed by the NSAC, in accordance with embodiments of the present disclosure.

FIG. 3 illustrates an exemplary functional architecture of various components of the NSAC architecture, in accordance with embodiments of the present disclosure.

FIG. 4 illustrates an exemplary signal flow diagram for updating a number of user equipment (UEs) with the NSAC, in accordance with embodiments of the present disclosure.

FIG. 5 illustrates an exemplary signal flow diagram for early access control (EAC), in accordance with embodiments of the present disclosure.

FIG. 6 illustrates an exemplary signal flow diagram for updating a number of packet data unit (PDU) sessions, in accordance with embodiments of the present disclosure.

FIG. 7A illustrates an exemplary signal flow diagram for registering network repository function (NRF) with a NSAC function (NSACF), in accordance with embodiments of the present disclosure.

FIG. 7B illustrates an exemplary signal flow diagram of the NSACF sending a heartbeat to the NRF for indicating an “Active” status, in accordance with embodiments of the present disclosure.

FIG. 8 illustrates an exemplary computer system in which or with which embodiments of the present disclosure may be implemented.

The foregoing shall be more apparent from the following more detailed description of the disclosure.

### DETAILED DESCRIPTION OF DISCLOSURE

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Certain terms and phrases have been used throughout the disclosure and will have the following meanings in the context of the ongoing disclosure.

The term “NSACF” may refer network slice admission control function for tracking and regulating the number of registered user equipment (UEs) per network slice and/or the number of PDU Sessions per network slice.

The term “PDU” may refer to packet data unit sessions established in the 5G network.

The term “PLMN” may refer to public land mobile networks.

The term “AMF” may refer to access and access and mobility management function providing control plane network functions (NF) of the 5G core network.

The term “SMF” may refer to session management function for collecting information related to PDU session management from various network components in the 5G core network.

The term “SCP” may refer to service communication proxy for enabling dynamic scaling and management of communication and services in the 5G core network.

The term “NRF” may refer to network repository function maintaining the profiles of the available NF instances and their supported services in the 5G core network.

In some aspects, the present disclosure provides a robust and effective solution for managing UE and PDU sessions in a 5G network based on a NSACF. In some embodiments, an in-instance cache is maintained to count the number of UE/PDU session when numerous UE/PDU sessions are associated with the same network slice. In one or more embodiments, the data entries in the in-instance cache are retained in a linear and slice-wise pattern and are synced periodically to a database to ensure consistency between the cached data and the database. In some embodiments, the data is also synced to a standby instance, ensuring high availability (HA) so as to serve requests with its own in-instance cache during a switch-over.

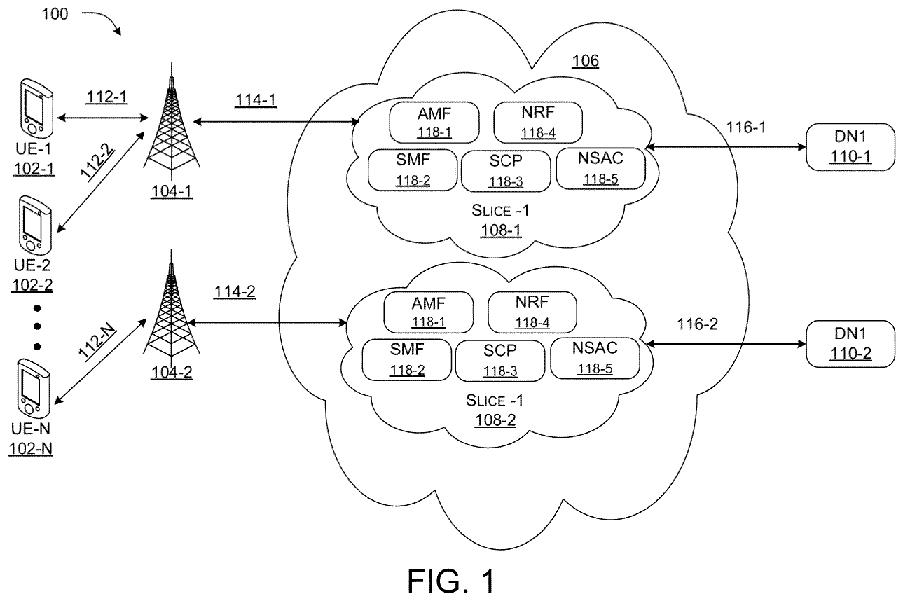

The various embodiments throughout the disclosure will be explained in more detail with reference to FIGS. 1-8.

FIG. 1 illustrates an exemplary network architecture (100) in which or with which embodiments of the present disclosure may be implemented.

Referring to FIG. 1, the network architecture (100) may include access points or gnodeBs (gNB) (104-1, 104-2) serving one or more user equipment (UEs) (102-1, 102-2 . . . 102-N). The UEs (102-1, 102-2 . . . 102-N) may be connected to one or more data networks (DNs) (110-1, 110-2) through a network (106) comprising one or more network slices (108-1, 108-2). The UEs (102-1, 102-2 . . . 102-N) may be connected to the gNBs (104-1, 104-2) through one or more links (112-1, 112-2 . . . 112-N). The gNBs (104-1, 104-2) may further be connected to network slices (108-1, 108-2) through links (114-1, 114-2), respectively. The network slices (108-1, 108-2) may be connected to the DNs (110-1, 110-2) via links (116-1, 116-2), respectively. A person of ordinary skill in the art will understand that one or more UEs (102-1, 102-2 . . . 102-N) may be individually referred to as the UE (102) and collectively referred to as the UEs (102), the one or more gNBs (104-1, 104-2) may individually be referred to as gNB (104) or collectively referred to as gNBs (104), the one or more network slices (108-1, 108-2) may be individually referred to as network slice (108) or collectively referred to as network slices (108), the one or more DNs (110-1, 110-2) may individually referred to as DN (110) or collectively referred to as DNs (110). Further, a person of ordinary skill in the art will understand that one or more links (112-1, 112-2, 112-N, 114-1, 114-2, 116-1, 116-2) may be individually referred to as the link (112, 114, 116) and collectively referred to as the links (112, 114, 116), respectively.

In an embodiment, each UE (102) may interoperate with every other UE (102) in the network architecture (100). In an embodiment, the UE (102) may be referred to as user devices or computing devices. A person of ordinary skill in the art will appreciate that the terms “user device(s),” “computing device(s),” and “UE” may be used interchangeably throughout the disclosure.

In an embodiment, the UEs (102) may include, but are not limited to, handheld wireless communication devices (e.g., a mobile phone, a smartphone, a phablet device, and so on), wearable computer devices (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of device with wireless communication capabilities, and the like. In an embodiment, the UEs (102) may include, but are not limited to, any electrical, electronic, electro-mechanical, or an equipment, or a combination of one or more of the above devices such as virtual reality (VR) devices, augmented reality (AR) devices, laptop, a general-purpose computer, desktop, personal digital assistant, tablet computer, mainframe computer, or any other computing device, wherein the user device (102) may include one or more in-built or externally coupled accessories including, but not limited to, visual aid devices such as camera, audio aid, a microphone, a keyboard, and input devices for receiving input from a user such as touch pad, touch enabled screen, electronic pen, and the like.

A person of ordinary skill in the art will appreciate that the user devices or UEs (102) may not be restricted to the mentioned devices and various other devices may be used.

Referring to FIG. 1, the UEs (102) may communicate with the DN (110) through the network (106). In an embodiment, the network (106) may include at least one of a non-standalone (NSA) 5G network, a standalone 5G network, or the like. The network (106) may enable the UEs (102) to communicate between various devices and/or with the DN (110). As such, the network (106) may enable the UEs (102) to communicate with other UEs (102) via a wired or wireless network. The network (106) may include a wireless card or some other transceiver connection to facilitate the communication. In an exemplary embodiment, the network (106) may incorporate one or more of a plurality of standard or proprietary protocols including, but not limited to, Wi-Fi, Zigbee, or the like. In another embodiment, the network (106) may be implemented as, or include various communication technologies such as, a wide area network (WAN), a local area network (LAN), a wireless network, a mobile network, a Virtual Private Network (VPN), an Internet, a Public Switched Telephone Network (PSTN), or the like.

Referring to FIG. 1, the network (106) may include the one or more network slices (108) enabling the connection of the UE (102) with the DN (110). The network slice (108) may include one or more modules for enabling session establishment between the UE (102) and the DN (110). The modules may include an AMF module (118-1), a SMF module (118-2), a SCP module (118-3), a NRF module (118-4), and a network slice admission control (NSAC) module (118-5).

In accordance with an embodiment of the present disclosure, the NSAC module (118-5) may control the number of UEs (102) registering to the network slice (108). The NSAC module (118-5) may also control the number of PDU sessions associated with the network slice (108).

In some embodiments, the NSAC module (118-5) may include an NSAC function (NSACF) for counting the number of UE (102) registered or the number of PDUs initiated for a particular network slice (108). The NSACF offers services to the AMF and the SMF via an interface referred to as an NSACF service-based interface. Further, the NSACF offers following functionalities to the network (106) such as, without limitations, meeting customer service level agreement (SLA) requirements with respect to network slice usage, protecting slice overload, obtaining slice usage metrics, loading balance traffic on multiple instances of network slices based on load conditions, and charging based on slice usage.

In an aspect, the NSACF may keep track of and regulate the number of registered UEs per network slice and/or the number of PDU sessions per network slice. The NSACF may monitor and control the number of registered UEs and/or the number of (PDU sessions per network slice. The NSACF is configured, in some examples, dynamically, with the maximum allowable number of UEs and/or PDU sessions per Single Network Slice Selection Assistance Information (S-NSSAI). Using the configured thresholds (i.e., maximum allowable number of UEs and/or PDU sessions), the NSACF may check whether the current count of UEs or PDUs exceeds the maximum limit. If the limit is exceeded, the NSACF may take appropriate actions, such as rejecting new admissions or applying admission control policies, to manage the slice resources effectively. The NSACF may also maintain the state of NSACF and makes admission control decisions based on the current conditions. In this way, the NSACF allows granular and dynamic control of network slice usage at runtime. In some aspects, the NSACF evaluates incoming network slice requests to determine whether they can be accommodated within the existing network infrastructure. This determination involves checking resource availability, including bandwidth, computing resources, and network capacity. Also, the NSACF monitors network slice usage, protects slice overload, obtains slice usage metrics, loads balance traffic on multiple instances of network slices based on load conditions, and charge based on slice usage. Based on the determination, the NSACF is aware of various aspects of network resources and services and allows granular level control on network slice usage. In some aspects, the NSACF sets thresholds for maximum network slice usage, after which the services to the UEs can be denied. Furthermore, the NSACF is configured to dynamically adapt to changing network conditions, such as congestion, traffic load, and fluctuating resource availability. In some aspects, the NSACF may adjust admission decisions associated with the network slice usage in real-time based on aforementioned determination to optimize resource utilization and maintain service quality as per SLA.

In an aspect, Nnsacf service-based interface is an interface exhibited by NSACF for providing services to the AMF and the SMF. The Nnsacf service-based interface is used to allow NF service consumers (e.g. AMF) to request NSACF to perform per slice admission control for the number of UEs/PDU sessions. Further, the Nnsacf service-based interface may enable consumer NF to check the availability per network slice and update number of UEs registered with a network slice, or number of UEs with at least one PDU session/PDN Connection established on a network slice in the case of EPC interworking, or the number of PDU sessions established on a network slice.

The NSACF may increment/decrement a counter in an in-instance cache based on the number of UEs (102) initiating the session or leaving the session. The in-instance cache may be associated with a database and may update the UE/PDU count in the database.

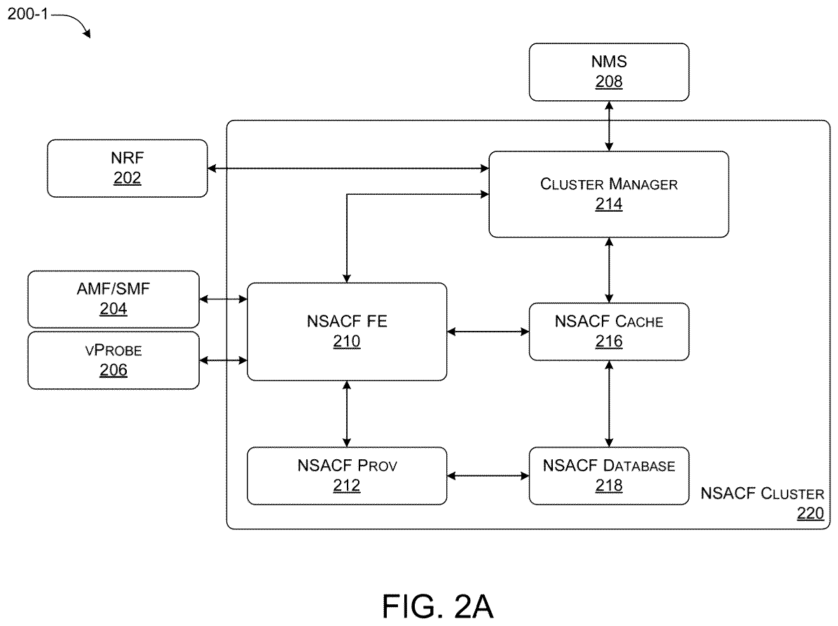

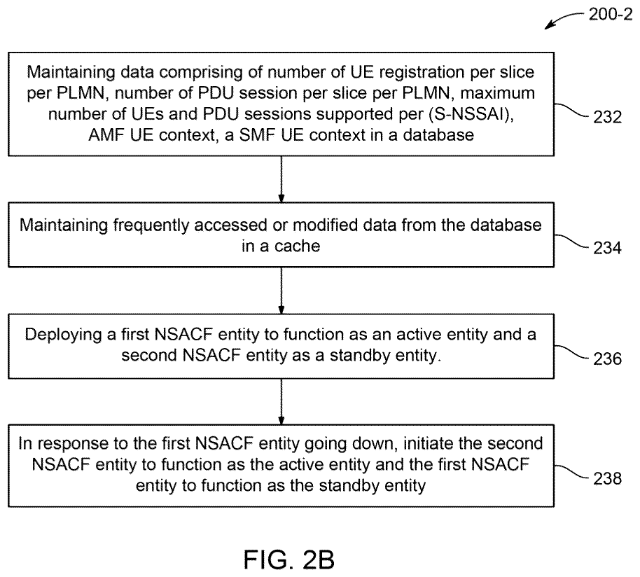

In some embodiments, there may be one or more NSAC module (118-5) wherein one of the NSAC module may actively serve the UEs (102) and the others may act as standby units. In some embodiments, the data from the in-instance cache may also be synced to a standby NSAC, ensuring high availability (HA). In an exemplary embodiment, if the serving NSAC gets overloaded, the standby NSAC may start to serve requests with its own in-instance cache during a switch-over. The detailed architecture of the NSAC module (118-5) is explained below with reference to FIG. 2A.

In an aspect, UE registers with one of the plurality of slices associated with an access management function (AMF). The number of UE registration per slice per public land mobile network (PLMN) is maintained in the database by the NSACF. In response to registration with the slice associated with the AMF, the UE performs a plurality of operations. The plurality of operations comprises accessing of data service, voice service, or both. In response to completion of operation, the UE deregisters with the slice associated with the AMF. On determining that the UE registers or deregisters, the NSACF is configured to increment or decrement the number of UE registration in the database, respectively.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

FIG. 2A illustrates an exemplary block diagram of a network slice admission control (NSAC) architecture (200-1), in accordance with embodiments of the present disclosure.

Referring to FIG. 2A, the NSAC architecture (200-1) may include one or more components that may work together to manage network slices and ensure proper admission control. The one or more components may include, such as, without limitations, a NRF module (202), an AMF/SMF module (204), vProbe (206), a network management station (NMS) (208), and a NSACF cluster comprising a NSACF function element (NSACF FE) (210), a NSACF provisioning unit (212), a cluster manager (214), a NSACF cache (216), and a NSACF database (218).

Referring to FIG. 2A, the NSACF control unit or the NSACF controller (200-1) architecture may be configured with a threshold associated with a maximum number of UE (102) and/or PDU sessions that are allowable per S-NSSAI. The NSACF controller (200-1) may monitor and control the number of registered UE (102) and/or the number of PDU sessions per network slice (108). In some embodiments, the NSACF controller (200-1) may check whether the current count of UEs or PDUs exceeds the maximum limit. If the limit is exceeded, the NSACF controller (200-1) may either reject new admissions or apply admission control policies, to manage the slice resources effectively. The NSACF controller (200-1) may also maintain a state of NSACF and make admission control decisions based on the current conditions associated with the NSACF. In some embodiments, the NSACF state may include an active state or a standby state, wherein the standby state may be a copy of the real time status of the active state.

Referring to FIG. 2A, the NSACF database (218) stores one or more information associated with network slices (108) such as, without limitations, the maximum number of UEs and PDU sessions that can be supported per S-NSSAI. Further, the NSACF database (218) may organize the data entries in a linear and slice-wise manner to eliminate nested inquiries and improve response time. In some examples, the data entries may be stored according to the network slice and within the stored slice data, the data entries may be stored, for example, sequentially, one after the other, without any segmentation or partitioning. In some examples, the data entries may be stored, for example, in logical segments under the corresponding network slices. In other words, each data element is stored in contiguous memory locations or logical segments under the corresponding slice. Organizing the data entries in a linear and slice-wise manner allows for more efficient retrieval and processing of specific segments of data without having to access the entire dataset. In an example embodiment, the NSACF database (218) may provide required slice information associated with the network slice (108) to the NSACF controller (200-1). When the NSACF controller (200-1) requires information about a specific network slice, the NSACF controller (200-1) retrieves the necessary data from the NSACF database (218). This enables the NSACF controller (200-1) to make informed decisions about admission control based on the available slice resources and the defined limits.

Referring to FIG. 2A, the NSACF cache (216) may act as the primary data source for the NSACF to improve the performance of the admission control function. In some embodiments, the NSACF cache (216) may store a copy of frequently accessed or modified data from the NSACF database (218). The use of NSACF cache (216) for storing the frequently accessed data may reduce response times for the NSACF and may also help alleviate the load on the NSACF database (218). Cache layer serves as a buffer for frequently requested information. In some embodiments, to maintain data consistency, the NSACF cache (216) is synchronized with the NSACF database (218). The NSACF database (218) may act as a secondary or backup data source managing an NSACF state information in real time.

Referring to FIG. 2A, the NSACF database (218) may include a data node cluster and a slice database application for storing configuration, slice mapping, and cluster configuration information. The NSACF database (218) may also store static data information such as, without limitations, number of UE registration per slice per PLMN, number of PDU session per slice per PLMN etc, and dynamic information, such as, without limitations, AMF UE context, SMF UE context, etc. In some embodiments, the data node cluster is a set of data nodes (DNs) deployed in an N-way active redundancy model. The data redundancy may be configured based on network requirements. In some embodiments, the DN cluster may include a DN server hosting two DNs. For example, without limitation, a data redundancy configuration may include 1 master and 1 slave or 1 master and 2 slave with local data redundancy. This configuration ensures both master and slave for any data is not hosted on the same server. Further, each DN in the DN cluster may periodically share information about self with all other DNs in the cluster. The information shared may include health status and partitioning information. Further, the NSACF database application front end may be aware of backend partition to enable proper load distribution across all data nodes. In some embodiments, the back-end nodes can be added on the fly to increase the transactional capacity of the backend.

In some embodiments, in case of failure of one DN in the cluster, the remaining DNs may automatically perform data migration to copy the partitions running on failed DN and may create new data masters to maintain the configured redundancy model. In case of DN failure, additional DN cluster starts seamless data migration to make a new node master for some partitions and slave for other partitions. Further in some embodiments, all the write requests are first written on the master DN, replica nodes are then synched with the master node to ensure data consistency. Even if any DN goes down abruptly, no data is lost as the DNs synchronize data to ensure a hundred percent consistency of data among replica data nodes, wherein the replica data nodes for each partition are chosen automatically across racks for redundancy. For a pair of DNs in a data centre without geo-redundancy, both servers/blades can be placed within/across the racks depending on redundancy requirements. For Geo-Redundancy (GR) a separate database cluster shall be established, and data across both the clusters will be replicated in asynchronous mode. Near real time two-way Active/Active replication channel is established with Data nodes cluster on GR site.

In some embodiments, all these data nodes are capable of automatically coming up after failures due to software related faults. Recovery of data node after failure and re-synchronization of partition data is also automatic and it does not require any manual action. Failure of one data node, however, does not lead to service outage as other data nodes hosting data of that partition are available to service the application queries. In some embodiments, the health status and operational status of all data nodes in the cluster are continuously monitored and all such health-related events are reported to the cluster manager (214).

Referring to FIG. 2A, the NSACF provisioning unit (NSACF Prov) (212) may store the maximum number of UEs (102) and PDU sessions that may be supported per S-NSSAI and may also maintain reference count data for all slices associated with their respective PLMNs served by the SMF/AMF module (204). Further, the NSACF Prov (212) may store information about the reference count data of all SMFs and AMFs served by a specific slice and PLMN ID to facilitate managing and provisioning network resources effectively, ensuring that the slice admission control decisions align with the available capacities and network policies.

In some embodiments, the NSACF cluster may be deployed in a pair, wherein one peer actively serves the UE/PDU session request, and the second peer remains on a standby. Further, the standby peer may fetch the count of UE/PDU session served by the active peer from the NSACF cache (216). By way of example, without limitations, if the actively serving peer is down, the standby peer takes over the UE/PDU sessions, thereby ensuring high availability of the NSACF. The peer that went down may now be the standby peer. The NSACF Prov (212) may implement an active-standby model to provide a high availability feature. Further, the NSACF Prov (212) may also include a shared global cache with concurrent access. Further, the NSACF Prov (212) may keep track of the count of UEs/PDUs for all network slices (108) of FIG. 1, along with their respective PLMN ID and SMF and AMF details to provide statistics on UE/PDU load distribution across different network slices (108) served by the AMF/SMF. In some embodiments, the data stored by the NSACF Prov (212) may be utilized to determine which slice should be chosen for an AMF based on the internal slice distribution strategy of a client or consumer. The NSACF Prov (212) may also provide a slice load distribution percentage associated with one or more AMF allowing users to identify all the AMF/SMF served by a particular network slice (108). This information may be used for risk calculation to determine which AMF/SMF will be impacted if a specific slice becomes unavailable.

In some embodiments, the NSACF Prov (212) may provide slice statistics per access type, indicating the percentage of registered UEs and PDUs that are 3GPP and non-3GPP. This may enable users to understand the occupancy of a particular slice based on the access type.

In some embodiments, the NSACF Prov (212) may include a provisioning application serving as a gateway application providing application program interface (API) support to provision the number of UE registrations and number of PDU sessions for admission control. In some embodiments, the NSACF Provisioning Application may be deployed in Active-standby mode or Active-Active mode.

Referring to FIG. 2A, the NSACF controller (200-1) may run in containerized environment and may be respawned in case of fault.

Referring to FIG. 2A, the cluster manager (CM) (214), otherwise referred to as the universal cluster manager (UCM) 214, may provide all the NRF (202) interface related functionalities on behalf of NSACF FE (210) and Provisioning Micro Service applications or NSACF Prov (212) acting as a NRF client. The UCM (214) may support performance counters, faults, configuration and high availability view of different components in the NSACF controller (200-1). The UCM (214) may be integrated with NRF module (202) and NMS (208) interfaces. Further, the UCM (214) may support 2N redundancy model. In some embodiments, the UCM (214) may include the following functionality: a UCM application which may serve as an http interface for fault, configuration, accounting, performance, and security (FCAPS), a decision of Active/standby role, installation of virtual internet protocol (VIP), and provisioning for UCM communication. Further, the UCM (214) may also support hypertext transfer protocol 2 (HTTP2) stack for establishing connection with a peer NF. For example, without limitations, when NSACF controller (200-1) subscribes to any NF from NRF module (202), notification from the NRF module (202) may be received on http2 stack. The active UCM (214) may select the respective http2 stack for the NRF communication. The UCM (214) may communicate with http2 stack to send and receive requests towards the NRF module (202).

Referring to FIG. 2A, the NSACF controller (200-1) may include the NSACF FE (210) with an NSACF FE application for handling the traffic from peer NFs like AMF and SMF and the admission control based on number of UE registration and number of PDU sessions. Further, the NSACF FE (210) may also provide an early admission control (EAC) support by processing the request based on the provisioned information from the NSACF provisioning application. The EAC support may apply when user defined threshold may be used to notify AMF about the EAC Active/Inactive flag. In some embodiments, the NSACF FE application may support Active-Standby mode. In an aspect, the EAC Notify service operation is used by the NSACF to configure the EAC mode for S-NSSAI to the NF Service Consumer (e.g. AMF). The EAC Notify service operation shall be triggered when the NSACF sets the EAC flag for the S-NSSAI to “ACTIVE” if the number of UEs registered to an S-NSSAI is above certain threshold or set the EAC flag for the S-NSSAI to “INACTIVE” if the number of UEs registered to an S-NSSAI is below a certain threshold. The activation threshold and the deactivation threshold may be same or different.

A person of ordinary skill in the art will understand that the NSACF controller (200-1) may include the following features and function.
(i) Admission control on number of UE registrations—NSACF may support Admission Control on number of UE Registration based on Network Slice with per PLMN level control. NSACF may also provide option to user to control the admission control based on number of UE Registration defined based on Access Type (3GPP/Non-3GPP).
(ii) Admission Control on Number of PDU Session establishment—NSACF may support Admission Control on number of PDU Session establishment based on Network Slice with per PLMN level control. NSACF also provides option to user to control the admission control based on number of PDU Session establishment defined based on the Access Type (3GPP/Non-3GPP).
(iii) Early Admission Control support—NSACF may support for Early Admission Control (EAC) for optimized registration flow. This may be applicable only for Number of UE Registration use case where user defined threshold can be used to notify AMF about the EAC Active/in Active flag.
(iv) Multiple Slice Support—NSACF may extend the support for admission control simultaneously for multiple slices defined in NSACF. This may be applicable for multiple slice control per UE.
(v) AMF Context Management—NSACF may maintain Per AMF context with details of UEs registered per network slice allowing a user to identify the AMF to which the UE is currently attached and may provide the data such as number of UE Registered with specific AMF.
(vi) SMF Context Management—NSACF may maintain Per SMF context with details of PDU Sessions context per network slice and a user may provide the data such as number of PDU Sessions with specific SMF.
(vii) UE Context Management—NSACF may maintain UE context with details of Slice/AMF-Instance/SMF-Instance, Session-IDs, Access-Types, etc.
(viii) NRF communication support—NSACF may register with NRF when it becomes functional after application start-up process succeeds. This in turn may help other consumers to discover NSACF.
(ix) Multi-Tenancy Support—NSACF may provide support for multi-tenancy for hosting admission control of network slices of multiple PLMNs.
(x) SCP Support—The SCP may perform key functions to simplify the core's routing topology and offload the NRF from discovery functionality to enabling greater SBA scale. These include load balancing, message manipulation, message distribution, overload handling, traffic prioritization and message correlation.

A person of ordinary skill in the art will appreciate that the exemplary block diagram of the NSACF controller (200-1) may be modular and flexible to accommodate any kind of changes in the NSACF controller (200-1).

FIG. 2B illustrates an exemplary flow diagram (200-2) for network slice admission control performed by the NSAC, in accordance with embodiments of the present disclosure.

At step (232) of the flow diagram (200-2), maintaining the data in the database. The data comprises number of user equipment (UE) registration per slice per public land mobile network (PLMN), number of packet data unit (PDU) session per slice per PLMN, maximum number of UEs and PDU sessions supported per a single—network slice selection assistance information (S-NSSAI), an access management function (AMF) UE context, a session management function (SMF) UE context.

At step (234) of the flow diagram (200-2), maintaining frequently accessed or modified data from the database in a cache. The cache is in sync with the database.

At step (236) of the flow diagram (200-2), deploying as a first NSACF entity and a second NSACF entity. The first NSACF entity is an active entity and the second NSACF entity is a standby entity. The standby entity is configured to remain up in standby mode and fetch the cache served by the active entity.

At step (238) of the flow diagram (200-2), in response to the first NSACF entity going down, initiating the second NSACF entity to function as the active entity and the first NSACF entity to function as the standby entity.

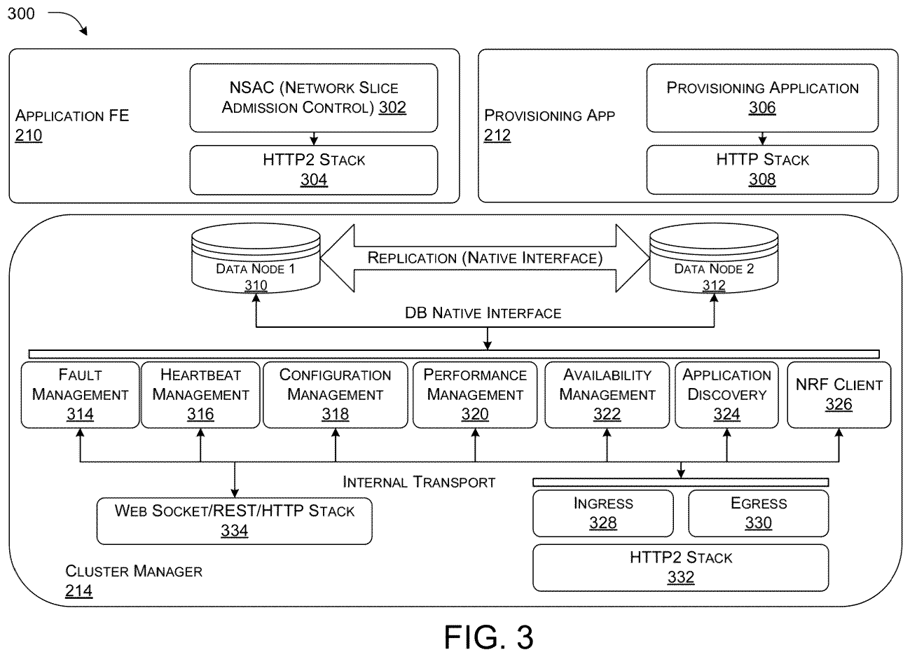

FIG. 3 illustrates an exemplary functional architecture (300) of various components of the NSAC controller (200-1), in accordance with embodiments of the present disclosure.

Referring to FIG. 3, the functional architecture (300) includes the application NSACF FE (210) comprising NSAC (302) and a HTTP-2 stack (304), the NSACF prov (212) includes a provisioning application (306) and a HTTP stack (308), the cluster manager (214) includes data nodes DN1 (310) and DN2 (312), a fault management module (314), a heartbeat management module (316), a configuration management module (318), a performance management module (320), an availability management module (322), an application discovery module (324), a NRF client (326), an ingress point (328), and an egress point (330), a HTTP2 stack (332), and a web socket/representational state transfer (REST)/HTTP stack (334).

A person of ordinary skill in the art will understand that the application FE (210), NSACF provisioning (212), and the data nodes of the cluster manager (214) are discussed above with reference to FIG. 2A and may not be discussed again for the sake of brevity.

Referring to FIG. 3, the fault management module (314) may integrate with the NMS (208) of FIG. 2A to provide fault information for a specific NSACF cluster. In some embodiments, the cluster manager (214) may raise a fault, whenever it gets error response for NF profile register/update request from NRF server or gets error response for heartbeat request from NRF server. Cluster manager (214) may also raise a fault, when an HTTP-2 provider layer's micro service goes down or when there are faults related to database like disk, memory thresholds, DN down, and DB cluster down.

Referring to FIG. 3, the heartbeat management module (316) may send periodic updates to the NRF (202) of FIG. 2A for the service availability of the specific NSACF cluster in the network. The configuration management module (318) may integrate with a configuration management system which may help to push the configuration changes into the NSACF cluster.

Referring to FIG. 3, the performance management module (320) may integrate with a performance management system to key performance indicators data specific to NSACF cluster. The cluster manager (214) may have a template for NRF interface counters for NF profile management, discovery and access token service and support HTTP2 provider layer's application (PL) performance counters.

In some embodiments, the availability management module (322) may maintain the high availability or redundancy among the NSACF cluster. The application discovery module (324) may perform application discovery function for the NSACF services. The NRF client (326) may integrate with the SCP or NRF for the registration, update, or delete the NSACF profile. For example, the cluster manager (214) may be in active standby redundancy. The active cluster manager may relay information of all registered micro service endpoints to the standby cluster manager.

In some embodiments, the cluster manager (214) may include an alarm management module (not shown in FIG. 3) and a log management module (not shown in FIG. 3). The cluster manager (214) may change the severity of an alarm and the alarm may then be raised with the updated severity. In some embodiments, the cluster manager (214) may suppress an alarm by changing its admin state to disable. Further, an alarm's admin state may be changed to enable. The alarm may be cleared via HTTP interface on the cluster manager (214). In some embodiments the cluster manager (214) may support changing log level of different micro services in the cluster on run time.

A person of ordinary skill in the art will appreciate that the exemplary function architecture (300) of the NSACF controller (200-1) may be modular and flexible to accommodate any kind of changes in the NSACF controller (200-1).

In some embodiments, a NSAC or NSACF? service may be used by an NF service consumer to request admission control for UEs accessing a specific network slice or for PDU sessions to be established for specific network slice. The NF service consumer discovers the NSACF based on the local configuration or from NRF. The NSAC or NSACF? service may perform one or more of the following functions:
(i) Request the NSACF to control the number of UEs registered to a specific network slice, e.g. perform availability check and update the number of UEs registered to a specific network slice.
(ii) Request the NSACF to control the number of PDU session established to a specific network slice, e.g. perform availability check and update the number of PDU sessions established to a specific network slice.
(iii) Notify the NF Service Consumer (e.g. AMF) of the activation/deactivation of EAC (Early Admission Control) mode for NSAC procedure.

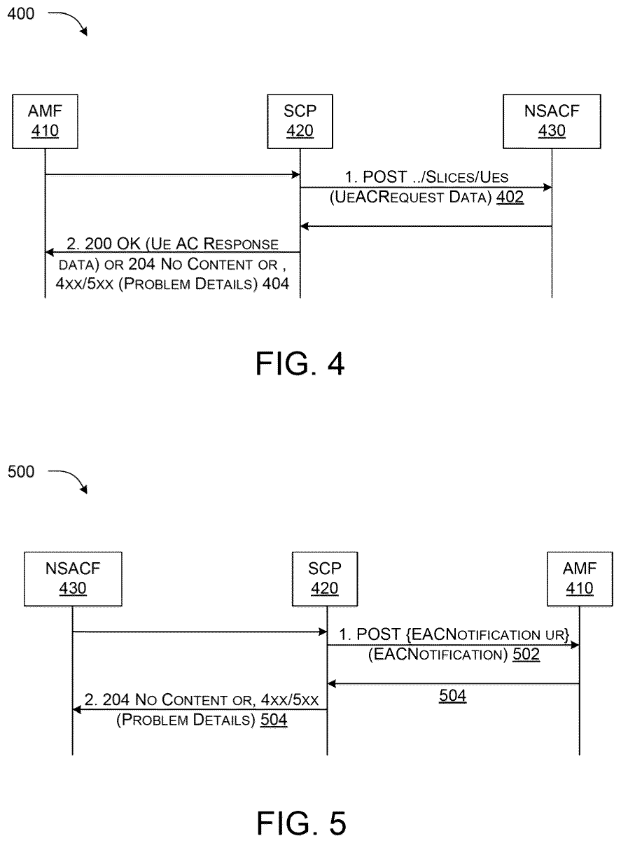

In some embodiments, the following operations:
(i) NumOfUEsUpdate
(ii) NumOfPDUsUpdate
(iii) EACNotify. are defined in the Nnsacf_NSAC service and are explained in detail below with reference to FIGS. 4-6 .

FIG. 4 illustrates an exemplary signal flow diagram (400) for updating the number of UEs with the NSAC, in accordance with embodiments of the present disclosure.

In some embodiments, the NumOfUEsUpdate service operation may be used by the NF service consumer, for example, the AMF, to request the NSACF to control the number of UEs registered to a specific network slice. For example, the NumOfUEsUpdate service performs availability check and updates the number of UEs registered to a network slice during UE Registration/Mobility/UE Update depending on triggers defined by the AMF. The operation may also be used to update the number of existing registered UEs in the NSACF when NSAC is enabled or disabled for a slice that is already live in the network. The AMF may trigger this procedure after or before the registration is completed based on the EAC mode.

Referring to FIG. 4, the AMF (410) may send a POST (402) request to the NSACF (430) via the SCP (420). The payload body of the POST request may contain the input data structure, for example, UEACRequestData for network slice admission control, which may contain: subscription permanent identifier (SUPI) of UE, AccessType, List of S-NSSAI with associated Update Flag (Set to INCREASE or DECREASE), NFInstance ID, e.g. the AMF (410). The payload body may also contain, among other data, notification uniform resource identifier (URI) to be used for EAC Notify. For roaming subscriber case, the AMF (410) may also provide S-NSSAI in serving PLMN and corresponding mapped S-NSSAI in home PLMN. The request is processed at the NSACF (430) based on existing UE Context present and received data from the AMF (410), based on which a response (404) is sent back to the AMF (410) through the SCP (420).

FIG. 5 illustrates an exemplary signal flow diagram (500) for early access control (EAC), in accordance with embodiments of the present disclosure.

In some embodiments, the EACNotify service operation may be used by the NSACF (430) to configure the EAC mode for S-NSSAI to the NF service consumer, for example, the AMF (410). The EACNotify service operation may be triggered when the NSACF (430) decides to set the EAC mode for an S-NSSAI to “ACTIVE” if the number of UEs registered to an S-NSSAI is above a desired threshold or set the EAC mode for an S-NSSAI to “DEACTIVE” if the number of UEs registered to an S-NSSAI is below the desired threshold. The activation threshold and the deactivation threshold may be same or different.

Referring to FIG. 5, the NSACF (430) may send a POST request (502) to the EAC Notification callback URI provided by the AMF (410) during the number of UEs Update Procedure as explained above with reference to FIG. 4. In some embodiments, the payload body of the POST request may contain the notification payload (i.e. EACNotification), which shall contain the following information: S-NSSAI, and EAC mode for S-NSSAI. On successful processing of the POST request (502) from the NSACF (430), the AMF (410) may send a response (504) comprising “204 No Content” to the NSACF (430) via the SCP (420). In some embodiments, the payload body of the POST response (504) from the AMF (410) may be empty.

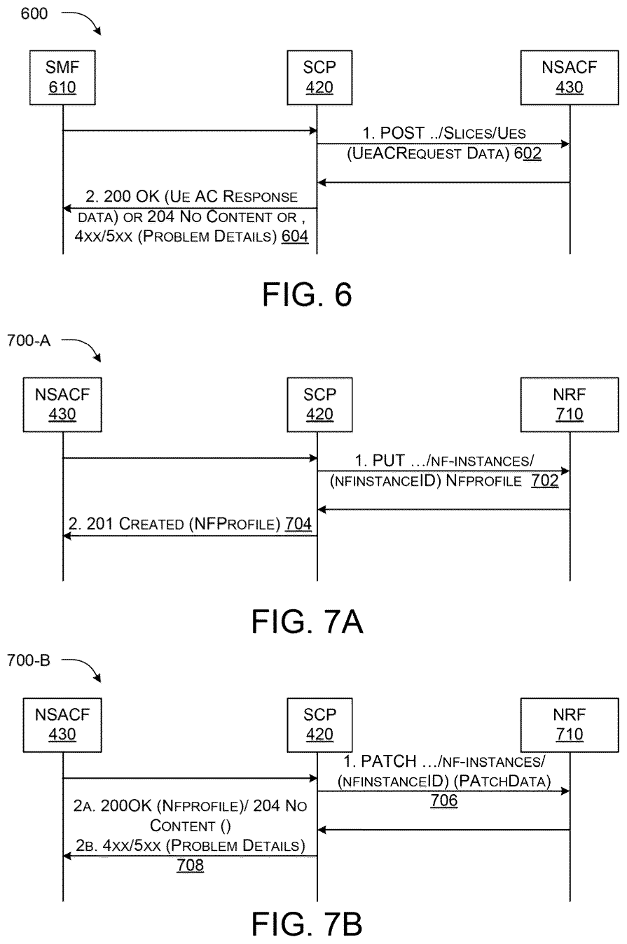

FIG. 6 illustrates an exemplary signal flow diagram (600) for updating the number of the PDU sessions, in accordance with embodiments of the present disclosure.

In some embodiments, an NF Service Consumer for example, the SMF (610) may use the NumOfPDUsUpdate service operation, to request the NSACF (430) to control the number of PDU sessions registered to a specific slice, e.g. perform availability check and update the number of PDU sessions registered to a slice. The operation may also be used to update the number of existing PDU sessions in the NSACF (430) when NSAC is enabled or disabled for a slice that is already live in the network.

Referring to FIG. 6, the SMF (610) may send a POST request (602) to the NSACF (430) via the SCP (420) related to the number of PDU sessions. The payload body of the POST request (602) may contain the input data structure (i.e. PDUACRequestData) for network slice admission control. The PDUACRequestData will include parameters: SUPI, AccessType, PDU Session ID, list of S-NSSAI, and Update Flag (INCREASE/DECREASE/UPDATE). Optionally, it may also contain NFInstance ID, for example, the ID associated with the SMF (610). The POST request (602) is processed at the NSACF (430) based on at least one of an existing contexts and a received data from the SMF (610) based on which a response (604) is sent back from the NSACF (430) towards the SMF (610).

FIG. 7A illustrates an exemplary signal flow diagram (700-A) for registering network repository function (NRF) with the NSACF, in accordance with embodiments of the present disclosure.

In some embodiments, the NSACF (430) may register a single NF profile for the NSACF instances with the NRF (710), wherein the registration may be enabled by the UCM (214) of FIG. 2A.

Referring to FIG. 7A, the registration may be initiated by sending a PUT request message (702) from the NSACF (430) to the NRF (710) via the SCP (420). The PUT request message (702) may include an individual subscription ID of the NF requesting the subscription. Upon receiving the PUT request message (702), the NRF (710) may respond with a “201 created profile” response message (704).

FIG. 7B illustrates an exemplary signal flow diagram (700-B) for NSACF sending heartbeat to NRF for indicating an “Active” status, in accordance with embodiments of the present disclosure.

In some embodiments the NSACF (430) may send continuous heartbeat to NRF as per negotiated heartbeat time, using the NFUpdate service operation, in order to show that the NSACF is still operative.

In an aspect, NFUpdate service operation allows an NF Instance to replace, or update partially, the parameters of its NF profile (including the parameters of the associated services) in the NRF; it also allows to add or delete individual services offered by the NF Instance. This service operation is not allowed to be invoked from an NRF in a different PLMN. The NFUpdate service operation may update the profile of a Network Function previously registered in the NRF by providing the updated NF profile of the requesting NF to the NRF. The update operation may apply to the whole profile of the NF (complete replacement of the existing profile by a new profile), or it may apply only to a subset of the parameters of the profile (including adding/deleting/replacing services to the NF profile).

In an aspect, in NF Heart-Beat, each NF that has previously registered NRF may contact the NRF periodically (heartbeat), by invoking the NFUpdate service operation, in order to show that the NF is still operative. The time interval at which the NRF shall be contacted is deployment-specific, and it is returned by the NRF to the NF Service Consumer as a result of a successful registration. When the NRF detects that a given NF has not updated its profile for a configurable amount of time (longer than the heart-beat interval), the NRF changes the status of the NF to SUSPENDED and considers that the NF and its services can no longer be discovered by other NFs via the NFDiscovery service. The NRF notifies NFs subscribed to receiving notifications of changes of the NF Profile that the NF status has been changed to SUSPENDED. If the NRF modifies the heart-beat interval value of a given NF instance currently registered (e.g. as a result of an OA&M operation), it shall return the new value to the registered NF in the response of the next periodic heart-beat interaction received from that NF and, until then, the NRF shall apply the heart-beat check procedure according to the original interval value.

Referring to FIG. 7B, the NSACF (430) may send the heartbeat messages to the NRF (710) as a PATCH request (706) and obtain a “200OK” response (708) indicating the successful processing of the request.

A person of ordinary skill in the art will appreciate that these are mere examples, and in no way, limit the scope of the present disclosure.

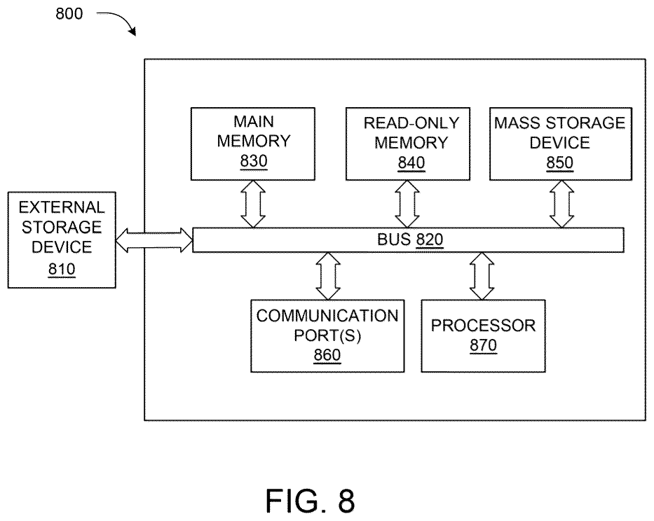

FIG. 8 illustrates an exemplary computer system (800) in which or with which embodiments of the present disclosure may be utilized. As shown in FIG. 8, the computer system (800) may include an external storage device (810), a bus (820), a main memory (830), a read-only memory (840), a mass storage device (850), communication port(s) (860), and a processor (870). A person skilled in the art will appreciate that the computer system (800) may include more than one processor and communication ports. The processor (870) may include various modules associated with embodiments of the present disclosure. The communication port(s) (860) may be any of an RS-232 port for use with a modem-based dialup connection, a 10/100 Ethernet port, a Gigabit or 10 Gigabit port using copper or fibre, a serial port, a parallel port, or other existing or future ports. The communication port(s) (860) may be chosen depending on a network, such a Local Area Network (LAN), Wide Area Network (WAN), or any network to which the computer system (800) connects. The main memory (830) may be random access memory (RAM), or any other dynamic storage device commonly known in the art. The read-only memory (840) may be any static storage device(s) including, but not limited to, a Programmable Read Only Memory (PROM) chips for storing static information e.g., start-up or basic input/output system (BIOS) instructions for the processor (870). The mass storage device (850) may be any current or future mass storage solution, which may be used to store information and/or instructions.

The bus (820) communicatively couples the processor (870) with the other memory, storage, and communication blocks. The bus (820) can be, e.g. a Peripheral Component Interconnect (PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (870) to the computer system (800).

Optionally, operator and administrative interfaces, e.g. a display, keyboard, and a cursor control device, may also be coupled to the bus (820) to support direct operator interaction with the computer system (800). Other operator and administrative interfaces may be provided through network connections connected through the communication port(s) (860). In no way should the aforementioned exemplary computer system (800) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter to be implemented merely as illustrative of the disclosure and not as limitation.

### Advantages of the Present Disclosure

The present disclosure provides an improved management of slice distribution and utilization in the network.

The present disclosure improves utilization of network resources by preventing the admission of new user equipment (UE) registration and packet data unit (PDU) sessions when the network is overloaded.

The present disclosure improves user experience by preventing the denial of service to new UEs or PDU sessions.

The present disclosure increases network flexibility by allowing network operators to control the number of UEs and PDU sessions that can be admitted to each network slice.

We claim:

1. A network slice admission control function (NSACF), the NSACF is configured to:
maintain data in a database, wherein the data comprises number of user equipment (UE) registration per slice per public land mobile network (PLMN), number of packet data unit (PDU) session per slice per PLMN, maximum number of UEs and PDU sessions supported per a single network slice selection assistance information (S-NSSAI), an access management function (AMF) UE context, and a session management function (SMF) UE context;
maintain frequently accessed or modified data from the database in a cache, wherein the cache is in sync with the database;
deploy as a first NSACF entity and a second NSACF entity, wherein the first NSACF entity is an active entity and the second NSACF entity is a standby entity, wherein the standby entity is configured to remain in a standby mode and fetch the cache served by the active entity; and
responsive to the first NSACF entity going down, initiate the second NSACF entity to function as the active entity and the first NSACF entity to function as the standby entity.

2. The NSACF claimed as claim 1, wherein the NSACF is configured to provide slice statistics per access type to indicate percentage of plurality of registered UEs and plurality of PDUs, wherein the access type includes a third-generation partnership project (3GPP) access, non-3GPP access or both.

3. The NSACF claimed as claim 1, wherein the NSACF is configured to provide load distribution percentage of each slice of plurality of slices based on the AMF, wherein the AMF/SMF served by each slice is identified based on the load distribution percentage of each slice of the plurality of slices, wherein the NSACF is configured to determine UE/PDU load distribution percentage of the plurality of slices served by the AMF/SMF by tracking count of the UEs and the PDUs for all slices with respective PLMNs served by the AMF or the SMF.

4. The NSACF claimed as claim 1, wherein the NSACF is configured to handle traffic from a plurality of network functions (NFs) based on number of UE registration and number of PDU sessions, wherein a NSACF function element (FE) is configured to provide an early admission control (EAC) using an EAC flag.

5. The NSACF claimed as claim 4, wherein the NSACF is configured to set the EAC flag for the S-NSSAI to be active on determining that the number of UEs registered to the S-NSSAI is above a desired threshold and to set the EAC flag for the S-NSSAI to be inactive on determining that the number of UEs registered to an S-NSSAI is below the desired threshold.

6. The NSACF claimed as claim 1, wherein the NSACF is configured to increment/decrement a counter in the cache based on the number of UEs initiated or leaving the session.

7. The NSACF claimed as in claim 1, wherein on determining that the UE registers or deregisters, the NSACF is configured to increment or decrement the number of UE registration, respectively.

8. A method for performing network slice admission control by a network slice admission control function (NSACF), the method comprising:
maintaining data in a database, wherein the data comprises number of user equipment (UE) registration per slice per public land mobile network (PLMN), number of packet data unit (PDU) session per slice per PLMN, maximum number of UEs and PDU sessions supported per a single—network slice selection assistance information (S-NSSAI), an access management function (AMF) UE context, a session management function (SMF) UE context;
maintaining frequently accessed or modified data from the database in a cache, wherein the cache is in sync with the database;
deploying as a first NSACF entity and a second NSACF entity, wherein the first NSACF entity is an active entity and the second NSACF entity is a standby entity, wherein the standby entity is configured to remain in standby mode and fetch the cache served by the active entity; and
in response to the first NSACF entity going down, initiate the second NSACF entity to function as the active entity and the first NSACF entity to function as the standby entity.

9. The method claimed as claim 8 further comprising:
providing slice statistics per access type to indicate percentage of plurality of registered UEs and plurality of PDUs, wherein the access type includes 3GPP access, non- 3GPP access or both.

10. The method claimed as claim 8 further comprising:
providing load distribution percentage of each slice of plurality of slices based on the AMF, wherein all the AMF/SMF served by each slice is identified based on the load distribution percentage of each slice of a plurality of slices, wherein determining UE/PDU load distribution percentage of the plurality of slices served by the AMF/SMF by tracking count of the UEs and the PDUs for all slices with respective PLMNs served by the AMF or the SMF.

11. The method claimed as claim 8 further comprising:
handling traffic from a plurality of network functions (NFs) based on number of UE registration and number of PDU sessions, wherein a NSACF function element (FE) is configured to provide an early admission control (EAC).

12. The method claimed as in claim 11 further comprising:
setting an EAC flag for the S-NSSAI to be active on determining that the number of UEs registered to the S-NSSAI is above a desired threshold and setting the EAC flag for the S-NSSAI to inactive on determining that the number of UEs registered to an S-NSSAI is below the desired threshold.

13. The method claimed as in claim 8 further comprising:
incrementing/decrementing a counter in the cache based on the number of UEs initiated or leaving the session.

14. The method claimed as in claim 8 further comprising:
on determining that the UE registers or deregisters, incrementing or decrementing the number of UE registration, respectively.

15. A system for performing network slice admission control, the system comprising a network slice admission control function (NSACF), the NSACF is configured to:
maintain data in a database, wherein the data comprises number of user equipment (UE) registration per slice per public land mobile network (PLMN), number of packet data unit (PDU) session per slice per PLMN, maximum number of UEs and PDU sessions supported per a single network slice selection assistance information (S-NSSAI), an access management function (AMF) UE context, a session management function (SMF) UE context;
maintain frequently accessed or modified data from the database in a cache, wherein the cache is in sync with the database;
be deployed as a first NSACF entity and a second NSACF entity, wherein the first NSACF entity is an active entity and the second NSACF entity is a standby entity, wherein the standby entity is configured to remain in standby mode and fetch the cache served by the active entity; and
in response to the first NSACF entity going down, initiate the second NSACF entity to function as the active entity and the first NSACF entity to function as the standby entity.

16. The system claimed as claim 15, the NSACF is configured to provide slice statistics per access type to indicate percentage of plurality of registered UEs and plurality of PDUs, wherein the access type includes a third-generation partnership project (3GPP) access, non-3GPP access or both.

17. The system claimed as claim 15, the NSACF is configured to provide load distribution percentage of each slice of a plurality of slices based on the AMF, wherein all the AMF/SMF served by each slice is identified based on the load distribution percentage of each slice of plurality of slices, wherein the NSACF is configured to determine UE/PDU load distribution percentage of the plurality of slices served by the AMF/SMF by tracking count of the UEs and the PDUs for all slices with respective PLMNs served by the AMF or the SMF.

18. The system claimed as in claim 15, wherein the NSACF is configured to handle traffic from a plurality of network functions (NFs) based on number of UE registration and number of PDU Sessions, wherein a NSACF function element (FE) is configured to provide an early admission control (EAC).

19. The system claimed as in claim 15, wherein the NSACF is configured to set a EAC flag for the S-NSSAI to be active on determining that the number of UEs registered to the S-NSSAI is above a desired threshold and to set the EAC flag for the S-NSSAI to inactive on determining that the number of UEs registered to an S-NSSAI is below the desired threshold.

20. The system claimed as in claim 15, wherein the NSACF is configured to increment/decrement a counter in the cache based on the number of UEs initiating or leaving the session.

21. The system claimed as in claim 15, wherein on determining that the UE registers or deregisters, the NSACF is configured to increment or decrement the number of UE registration, respectively.

22. A user equipment (UE) attached to a network, the UE configured to:
register with one of the plurality of slices associated with an access management function (AMF), wherein number of user equipment (UE) registration per slice per public land mobile network (PLMN) is maintained in a database by a network slice admission control function (NSACF);
in responsive to registration with the slice associated with the AMF, perform a plurality of operations associated with services offered by the one of the plurality of slices; and
in responsive to completion of operation, deregister with the slice associated with the AMF, wherein on determining that the UE registers or deregisters, the NSACF is configured to increment or decrement number of UE registration in the database, respectively.

23. The UE claimed as in claim 22, wherein frequently accessed or modified data from the database is maintained in a cache, wherein the cache is in sync with the database.

24. The UE claimed as in claim 22, wherein the data comprises number of user equipment (UE) registration per slice per public land mobile network (PLMN), number of packet data unit (PDU) session per slice per PLMN, maximum number of UEs and PDU sessions supported per a single—network slice selection assistance information (S-NSSAI), an access management function (AMF) UE context, and a session management function (SMF) UE context.

25. The UE claimed as in claim 22, wherein the plurality of operations comprises accessing of data service, voice service or both.

26. A computer program product comprising a non-transitory computer-readable medium comprising instructions that, when executed by one or more processors, cause the one or more processors to execute a method for performing network slice admission control by a network slice admission control function (NSACF), the method comprising:
maintaining data in a database, wherein the data comprises number of user equipment (UE) registration per slice per public land mobile network (PLMN), number of packet data unit (PDU) session per slice per PLMN, maximum number of UEs and PDU sessions supported per a single—network slice selection assistance information (S-NSSAI), an access management function (AMF) UE context, a session management function (SMF) UE context;
maintaining frequently accessed or modified data from the database in a cache, wherein the cache is in sync with the database;
deploying as a first entity and a second entity, wherein the first entity is an active entity, and the second entity is a standby entity, wherein the standby entity is configured to remain up and fetch the cache served by the active entity; and
in response to the first entity going down, initiate the second entity to function as the active entity and the first entity to function as the standby entity.
